(19) United States
(12) Patent Application Publication
(10) Pub. No.: US 2010/0090037 A1
(43) Pub. Date: Apr. 15, 2010

(54) METHOD AND SYSTEM FOR TREATING MIXED MUNICIPAL AND SELECTED COMMERCIAL WASTE

(76) Inventors: Peter Hood, Surrey (GB); Stephen Smith, Greater London (GB); Iakovos Skourides, Nicosia (CY)

Correspondence Address: Roylance Abrams Berdo & Goodman, 1300 19th Street, N W Suite 600, Washington, DC, 20036, US

(21) Appl. No.: 12/312,924

(22) PCT Filed: Nov. 30, 2007
(86) PCT No.: PCT/GB2007/050731

§ 371 Date: Dec. 16, 2009

(30) Foreign Application Priority Data
Dec. 1, 2006 (GB) 0623987.5

(51) Int. Cl. B02C 21/00; B02C 19/00

(52) U.S. Cl. 241/23; 241/25; 241/65

(57) ABSTRACT

A method of treating municipal solid waste comprising the steps of: shredding the waste to a first particle size,—storing the shredded waste in an aerated storage bay (14) for a first period time; shredding at least some of the waste to a second particle size,—and agitating the shredded waste in a rotating drum (19) for a second period of time and then outputting the treated waste; wherein biological decomposition under aerobic conditions takes place in the aerated storage bay and the rotating drum.

The present invention relates to a method and system of processing mixed municipal solid waste (MSW) and selected commercial waste. In particular, the present invention relates to the treatment of MSW to produce a sustainable, alternative fuel product specifically using a biodrying process for the treatment of the biodegradable fraction of MSW.

Collection of recyclable materials at the kerbside is widely adopted in the UK and other countries, requiring households and other premises to sort their waste into a series of colour coded bins for the various waste types such as metal, glass, newspaper, cardboard and plastic. The contents of each bin are then collected from the household so that they can be recycled. This present approach to recycling may be expensive to implement and it may be impractical in some circumstances Garden waste may also be sorted separately at the household level for kerbside collection and composting. However, biodegradable kitchen and catering waste is usually discarded in the residual waste stream and is disposed of in landfill. Kerbside collection schemes increase the cost of waste recycling programmes and there is also uncertainty about the long-term markets for certain recyclables, such as high calorific value plastic wastes, and biodegradable waste.

The practice of disposing of waste in landfill sites is considered to present a significant potential risk to the environment. In particular, the anaerobic decomposition of biodegradable waste in landfill generates methane, which is a strong greenhouse gas (21 times stronger than carbon dioxide). Consequently, the European Landfill Directive 99/31/EC requires Member States to bring about a phased reduction in the amount of biodegradable MSW that is disposed of to landfill. A number of potential alternative strategies are available for the treatment of biodegradable MSW. The main routes currently being developed include:
Source segregation of the organic fraction and composting to produce a soil conditioning product;
Mechanical segregation and composting of the organic fraction to produce a low grade compost like output (CLO) that can be used as a landfill daily cover or for restoration of contaminated land;
Stabilisation of the biodegradable fraction to meet stability criteria permitting landfill disposal;
Mechanical segregation followed by anaerobic digestion to generate biogas as a supplementary fuel and stabilised residue suitable for land spreading.

Accordingly, land spreading in some form is currently the main alternative outlet for treated biodegradable MSW. Progress has been made with composting segregated greenwaste (i.e. garden waste) to produce a material suitable for land application. However, the treatment of waste containing catering and other food/kitchen wastes for land application is controlled by the EU Animal By-Products Regulation 1774/2002 as category 3 material and this requires an in-vessel composting process, which is a complex and expensive approach to produce what is effectively a soil conditioning material of low intrinsic value. Furthermore, composting treatment of biodegradable waste requires a minimum period of approximately three months to complete the process. There are also concerns about the quality and potential environmental impact of the CLO from mechanical segregation for general soil application, due to the presence of contaminants. Therefore markets for this type of material are currently restricted and these residues may ultimately be disposed of in landfill if they meet biological stability criteria. Nevertheless, they will continue to degrade slowly for very long periods of time in the landfill environment generating a potential long-term problem of methane release. The cost of treating waste by this approach is also high relative to the low grade end-product that is generated. Composted residuals from MSW, which may be suitable for land application must compete with a range of other organic materials for the available land bank, such as livestock manures, treated sewage sludge and industrial biowaste materials. Land application of composted residuals, as with all types of organic manure, is further restricted due to limits on the amount of nitrogen that can be applied to agricultural land in organic soil amendments within Nitrate Vulnerable Zones stimulated by the EU Nitrates Directive 91/676/EC. These controls restrict the rates of compost that can be applied which reduces the potential value of the compost as a soil conditioner and fertiliser material. Consequently, the economic and environmental viability and practicability of these approaches to biodegradable MSW management are uncertain.

An aim of the present invention is to provide a system and method that can process mixed MSW. Another object of the present invention is to provide a process for treating MSW such that a proportion of the waste does not need to be introduced into landfill sites and instead can be recycled to form a solid fuel which can be used for power generation or alternatively as a supplementary fuel for industrial processes, and particularly in cement manufacture.

According to a first aspect of the present invention there is provided a method of treating municipal solid waste comprising the steps of:

shredding the solid waste to a first particle size;

storing the shredded waste in an aerated storage bay for a first period of time;

shredding at least some of the waste to a second particle size; and

agitating the shredded waste in a rotating drum for a second period of time and then outputting the treated waste;

wherein biological decomposition under aerobic conditions takes place in the aerated storage bay and rotating drum.

The storage bay is usually an aerated static bay and the rotating drum may be described as a rotary biodryer.

In the method of the present invention, the municipal solid waste (MSW) is treated by microbiological activity which is referred to as biological decomposition. The waste that is treated by the method is dried as a result of the biological decomposition, so that the moisture content of the waste is reduced. The term biological decomposition is used to refer to the microbiological breakdown of the organic fraction of the mixed MSW to produce heat.

The treatment process is preferably carried out using bacteria in the upper mesophilic and thermophilic phases, which occur in the temperature range of above 40° C. and most preferably around 40° C. to 55° C. In this phase, very rapid decomposition occurs with the rapid production of heat. It is found that the reaction in the thermophilic phase is higher than the mesophilic phase which occurs in the range 30° C. to 40° C. Accordingly, accelerated decomposition of the waste takes place. However, if the temperature rises substantially above 55° C. microbial activity is reduced and almost stops at temperatures above 70° C.

The first particle size may be 100 mm or less and the second particle size may be 50 mm or less.

The first period of time may be approximately 72 hours.

The method may further comprise the step of controlling airflow through the storage bay such that the temperature of the shredded waste is maintained at approximately 50-55° C. Alternatively, the method may comprise the step of applying a heating cycle and a cooling cycle to the waste during the first period of time; wherein the maximum temperature of the heating cycle is approximately 55° C. and the minimum temperature of the cooling cycle is approximately 40° C.

Preferably, the average moisture level in the shredded waste after the first period of time is reduced to around 35% to 40% by weight, by metabolically generated heat. This has the effect of drying the waste so that the waste can be treated to form a solid fuel.

Preferably, the second period of time is approximately 48 hours.

The method may further comprise the step of periodically applying a heating cycle and a cooling cycle to the waste during the second period of time. The heating cycle may comprise exposing the waste to a first airflow rate at a time when the rotating drum is stationary; and the cooling cycle may comprise exposing the waste to a second airflow rate, higher than the first airflow rate, at a time when the rotating drum is rotating. The airflow is preferably supplied counter current to the direction of feeding waste into the rotary drum. The heating and cooling cycles and rotation schedule enhance microbial activity at limiting moisture contents and reduce heat losses so that drying of the waste occurs rapidly.

Preferably the duration of each heating cycle and each cooling cycle is controlled such that the temperature of the waste in the rotating drum is maintained between around 40° C. and 55° C.

The method may further comprise the step of: heating the second airflow to a temperature above the ambient temperature before it enters the rotating drum; wherein the second airflow is heated from heat generated from the biological decomposition in the storage bay.

Preferably, the average moisture level in the shredded waste after the second period of time is reduced to around 15% to 25% by weight, by metabolically generated heat. When the treated waste has been reduced to this moisture level it can be used as a solid fuel in power generation or as an auxiliary fuel in cement manufacture, for instance.

The method may further comprise the step of sorting, before the first shredding step, the MSW to remove non-combustible material from the waste.

The method may further comprise the step of feeding the treated waste from the rotating drum into a rotary dryer for a third period of time and heating the treated waste to a temperature of around 90° C. to reduce the average moisture level in the treated waste to around 15% by weight. The purpose of the rotary dryer is to reduce the moisture content of the waste further, if required, in order for the moisture content to be at an acceptable level for a solid fuel.

According to a second aspect of the present invention there is provided a system for treating municipal waste, the system comprising:

a first shredder arranged to shred the waste to a first particle size;

an aerated storage bay constructed to store the shredded waste;

a second shredder arranged to shred at least some of the stored waste to a second particle size;

a rotary drum arranged to agitate the waste; and

means for controlling the temperature and the moisture levels in the waste in the storage bay and the rotary drum such that biological decomposition under aerobic conditions takes place in the aerated storage bay and the rotating drum.

A rotary dryer may be provided and arranged to receive and reduce the moisture content of material output from the rotary drum.

An example of the present invention will be described with reference to the accompanying drawings in which:

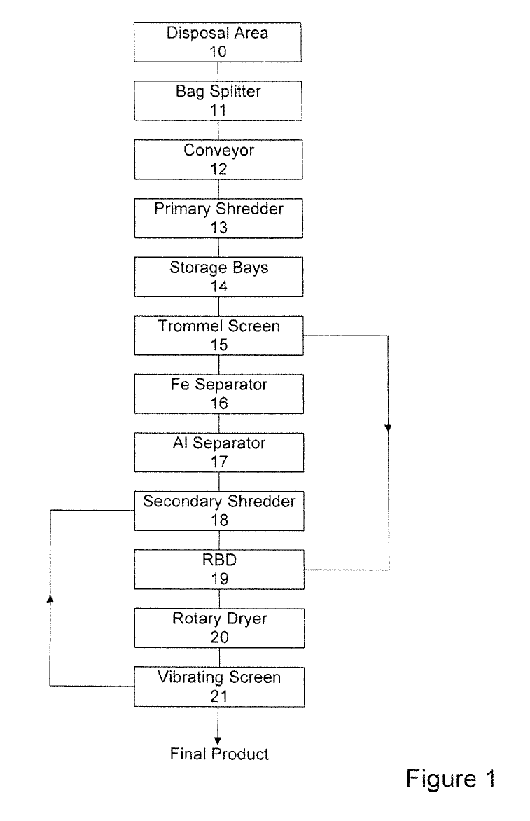

FIG. 1 shows a flow diagram of the system for treating MSW.

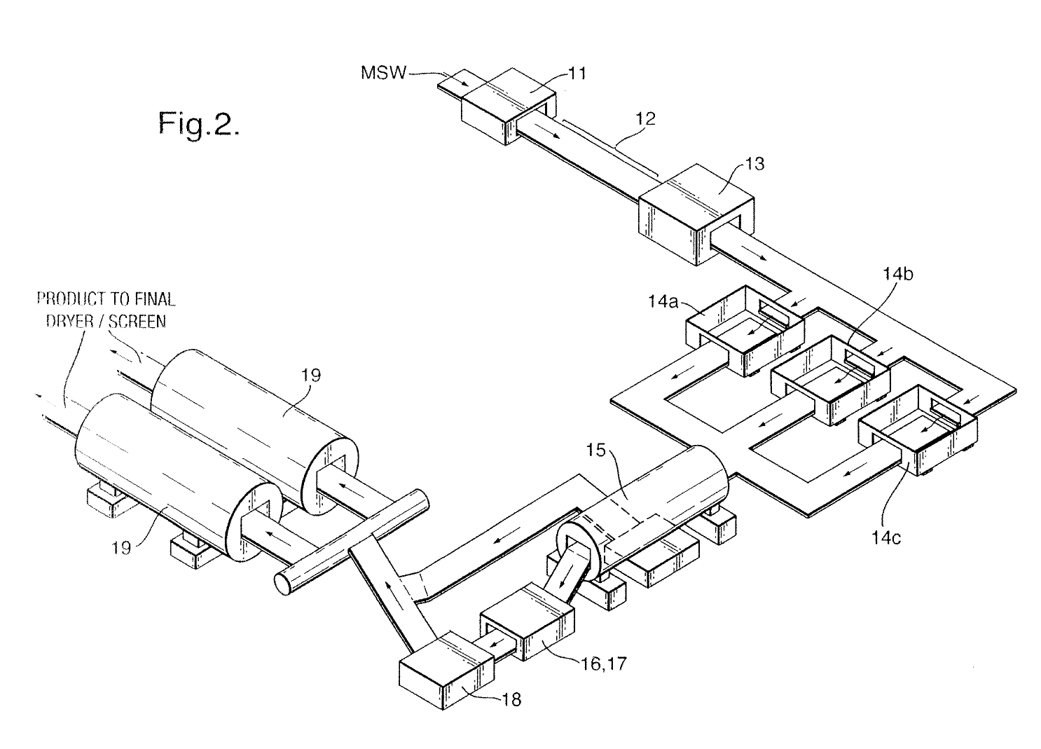

FIG. 2 shows a schematic view of a system for treating MSW.

As shown in FIG. 1 and FIG. 2 MSW is delivered to a disposal (receiving) area 10 having a concrete base. The waste will generally be contained within refuse bags and be composed of both domestic and industrial type waste.

The waste is then processed through a material recovery facility (MRF) which consists of a bag splitter 11 and a conveyor belt 12. The bag splitter 11 is standard in the industry and acts to release the MSW from the refuse bags. The waste is then fed onto the moving conveyor belt 12 where glass and dense plastic is manually removed from the waste stream, or, in an alternative embodiment, mechanical sorting processes, which are standard to the industry, may be employed.

The remaining material is then fed into a primary shredder 13. The primary shredder 13 acts to reduce the average particle size of the waste and it also acts to homogenise the wide variation of delivered waste. The primary shredder 13 is arranged to reduce the waste to a particle size of under 100 mm. The shredding process is very important because it also mixes the waste material thoroughly which spreads the active bacteria culture from organic waste dispersed throughout the material, helping to generate the necessary microbial reaction rapidly.

The average moisture content of the MSW to be treated can be controlled. The average moisture level of the waste at this stage of the process is preferably in the range of 30 to 60% by weight and more preferably 40 to 50% by weight.

After passing the MSW through the primary shedder 13 other waste materials may be blended with the shredded waste, for example, dewatered sewage sludge.

The desired moisture level may be obtained by blending MSW with other waste having a lower/higher average moisture level. It has been found that mixed domestic waste typically has a moisture level in excess of 30% by weight, and organic/kitchen waste may have a moisture level in excess of 75% by weight and sometimes 80% by weight, particularly in tropical and subtropical countries. Selected commercial waste from offices and factories is typically much drier, having a moisture level in the range of 10 to 20% by weight.

The primary shredder also allows absorbent material such as paper and paper based material (which is particularly common in commercial waste) to be blended with moist waste (such as organic/kitchen waste). The dry absorbent materials take up liquid contained in the waste, which promotes their biological decomposition and blending, leading to an improved reaction. Furthermore, the primary shredder 13 breaks down paper and cardboard which increases the surface area of the waste enhancing microbial activity.

A further parameter that may be controlled is the pH of the MSW. This is suitably in the range 6.0 to 8.5, preferably 6.3 to 7.3, and most preferably around 6.8. MSW that contains a large proportion of readily degradable organic food waste may undergo an initial acidification phase that inhibits microbial activity at the thermophilic range (above 40-45° C.). The pH of the material can be controlled with recycling of a proportion of the biodried product (10-20%) and mixing it with fresh material. Alternatively, initial high airflows maintaining the operating temperature below 40° C. can be applied during the first stage of the biodrying process, since mesophilic microorganisms are more tolerant to acidic conditions.

The output from the primary shredder 13 is fed to one of three aerated static bays 14a, 14b or 14c. The bays 14 are constructed from a concrete base and walls, and the waste material is retained within the bays for 72 hours. During these 72 hours, the material in each bay may be gently turned, for example by using mechanical shovels.

Airflow through the waste in the bays 14 is controlled by a temperature feedback system so that the temperature is controlled at approximately 50-55° C., which is standard to the industry.

In another example, an alternating temperature regime in the bays 14 may also be used with heating and cooling cycles having maximum and minimum control temperatures in the range of approximately 40° C. to 55° C., respectively. A temperature recording device (not shown) within each bay measures and records continuously the temperature of the waste in the bays 14. The temperature recording device within each bay is linked to a feedback control and aeration fan system. When the temperature of the waste in the bay 14 reaches the upper temperature limit of 55° C., fans are activated to provide airflow through the waste material to reduce the temperature of the waste to the lower temperature value. This cooling is achieved primarily from the latent heat from water evaporation, which is also responsible for drying the waste. When the minimum temperature value of 40° C. is reached, the fans are switched off and the heating cycle is repeated. In either example, the temperature is monitored and the airflow is controlled separately within each bay 14. In either example, the air may be supplied to the bays 14 under negative or positive pressure.

The bays 14 are used for initial biodrying of the waste and the waste begins to biodegrade in the bays 14 under carefully controlled conditions when the moisture content of the waste is adequate to support high microbial activity usually without the need for agitating the waste.

Biodrying occurs rapidly in a static treatment system when the moisture content of the waste is above 35 to 40%. However, microbial activity and production of metabolically generated heat are limited in static systems when the moisture content of the waste is below 35 to 40%. Microbial activity and therefore, the production of heat metabolically is limited below this moisture content as water supply from the waste to support microbial growth and physiological processes becomes restricted.

In the bays 14 the particle size of the waste should be relatively high to allow adequate porosity for aeration. The primary shredder reduces the size of the waste particles to a mean size near 100 mm that allows adequate porosity avoiding the need to apply high pressures to aerate the material in the static bays. The size of the waste particles may be shredded to a size in the range of 80 mm to 120 mm.

Owing to the microbiological activity in the waste in the bays 14, the temperature in the bays will rise to above 40° C. within six hours with a sufficient volume of waste. The bulk density in the bays will vary on delivery from 120-460 kg m⁻¹. Microbial breakdown and aeration within the first 24 hours will give an overall mean density between 200-250 kg m⁻³ with the corresponding moisture level between 40-50%. A skilled operator can assist in the initial homogenisation by selective loading of incoming MSW. This process is an aerobic process thus preventing generation of methane gas. Air that has passed through the waste from the static bays 14 for the purposes of cooling and drying the waste may be treated to prevent odour emissions by passing the air through a bioscrubber (not shown) that is standard to the industry.

After the waste has been stored in a bay 14 for 72 hours, it may be fed into a trommel screen 15, which is standard to the industry. This stage will depend on the extent of the initial level of sorting the waste prior to the aerated-static bays. The trommel screen 15 is a revolving cylindrical sieve and is arranged to separate out the organic fraction of the waste which has a particle size of less than 80 mm. The remaining waste, with a particle size above 80 mm, has a higher net calorific value than the separated organic waste. The organic waste of less than 80 mm particle size is fed into the system downstream of the trommel screen as described below.

The remaining waste from the trommel screen 15, that is the waste having a particle size greater than 80 mm, is passed first through a ferrous separator 16 and then an aluminum separator 17, to remove ferrous and aluminum materials from the waste stream. In an alternative example, metal separation may occur prior to entering the waste to the aerated-static bays 14. The ferrous and aluminum materials that have been removed can be recycled in a conventional manner.

The waste that has a particle size greater than 80 mm is then fed into a secondary shredder 18 that is arranged to reduce the particle size of the waste material to less than 50 mm.

The output from the trommel screen 15 that has a particle size of less than 80 mm and the output from the secondary shredder 18 is fed into a rotary biodryer (RBD) 19 which comprises a rotating drum formed of mild steel. Preferably the drum of the RBD may be insulated to conserve heat and increase the efficiency of the biodrying process. The output from the trommel screen 15 and the secondary shredder 18 is fed into the front end of the RBD 19 and after the material has been treated in the drum for a period of time, the material in the RBD 19 is removed from the rear end of the drum. The waste material is retained in the RBD 19 for up to 48 hours, during which time it dries under specifically controlled conditions for maximising aerobic decomposition, heat generation and biodrying.

In an alternative example, the waste from the trommel screen 15 that has a particle size greater than 80 mm and has passed through the separators 16, 17 is fed into the secondary shredder 18 along with the waste that has a particle size of less than 80 mm. The secondary shredder then acts to shred and blend the two waste streams before it is input into the RBD 19.

The RBD 19 is initially filled with waste to about 75% to 90% of its volume. The final product from the RBD 19 is a homogenised, odourless and stable product which can be used as solid recovered fuel.

The moisture content of the waste input 18 into the RBD 19 is in the range of 35 to 40% by weight of the waste. By keeping the waste material in the RBD 19 for upto 48 hours and under controlled conditions, the moisture content of the waste can be reduced to between 15 and 25% by weight.

The waste is agitated in the RBD 19 by rotation of the drum which significantly enhances microbial activity within the waste and biodrying of the waste. The agitation aids in the physical breakdown of the waste particles and continuously exposes alternating wet surfaces of the waste particles to micro-organisms. This agitation relocates the moisture from inside larger waste particles to the surface of smaller particles and the mixing of the waste facilitates the dispersion of micro-organisms to new substrates. The aeration regime ensures the adequate supply of oxygen to maintain aerobic conditions in the drum.

The temperature in the RBD 19 is controlled so that it is maintained between 40° C. and 55° C. which is achieved by using heating and cooling cycles. In the heating cycle, the RBD is held static for a period of time, for instance 1-2 hours, which is then followed, for instance, by 10 to 15 minutes of rotation. The frequent agitation sequences of a short duration have four aims which are: (1) to dry the waste, (2) to homogenise the material in the drum and prevent moisture or temperature gradients, (3) allow a representative measurement of the mean temperature inside the RBD to be recorded, (4) facilitate oxygen transfer to the whole mass of waste with minimal heat losses. During the heating cycle a continuous low airflow (for instance 30 to 35 m³ per hour per t (tonne) of waste) may be applied from an external source to support aerobic respiration of the waste in the RBD 19. Owing to this continuous low airflow, 60 to 70% of the heat that has been metabolically generated is stored in the waste and the temperature of the material in the RBD 19 can rise from 40° C. to 55° C. in 3 to 4 hours. In the heating cycle, the air that enters the RBD becomes saturated with water vapour (due to the low airflow) and condensation occurs in the RBD 19 which re-wets the surfaces of the waste particles, where most of the microbial activity occurs. This rewetting of the surfaces of the particles enhances the microbial activity and therefore high rates of metabolic heat generation are achieved, even though the waste may have very low average moisture content (by weight). The overall effect is that the temperature of the waste rises rapidly.

To prevent the temperature of the waste from increasing to an inhibitory level the waste material is cooled within the RBD 19 in cooling cycles as desired. If a temperature recording device fitted within the RBD determines that the temperature of the waste in the drum is higher than 55° C. after a heating cycle, a high airflow (equivalent to 120 to 150 m³ per hour per t of waste) is introduced in the RBD 19. The RBD 19 is also rotated at 0.5 revolutions per minute. The aim of the cooling cycle is to utilize the metabolically generated heat stored in the waste during a period when moisture is not limiting to microbial activity (i.e., during the heating cycle) in order to reduce the moisture content of the treated waste to a value that is suitable for use as a solid recovered fuel. The moisture content of the waste within the RBD 19 is also reduced to a level that ultimately prevents microbial activity due to moisture limitation and the treated product is therefore stable and can be stored without re-heating due to microbial activity.

The airflow introduced into the RBD 19 during the cooling cycle may be cold, ambient or preheated air. However, the efficiency of the cooling cycle can be increased by using preheated air during a cooling cycle. For example, the airflow introduced into the RBD 19 during the cooling cycle may be preheated from waste heat generated from the biodrying stage in the channels 14 using an air-to-air heat exchanger (not shown). Preheating the airflow introduced into the RBD 19 during the cooling cycle (by an external source) increases the efficiency of the biodrying process by maximising the moisture holding capacity of the air in the RBD, avoiding excessive cooling at the point of entry of the air into the RBD and reducing the level of condensation in the RBD.

During the cooling cycles, the heat stored in the waste in the RBD is efficiently utilised to remove moisture from the RBD and the waste material. The duration of each cooling cycle is between 45 and 70 minutes and therefore, high thermal gradients with respect to the ambient environment are maintained only for relatively short periods of time which reduces radiant heat losses from the surface of the RBD.

Air that has passed through the RBD 19 for the purposes of cooling and drying the waste from the RBD may be treated to prevent odour emissions by passing the air through a bioscrubber (not shown) that is standard to the industry.

The output from the RBD 19 can optionally be fed into a conventional rotary dryer 20 to further reduce the moisture content within the material. This may be used for instance in excessively wet environmental conditions when the waste material at the input of the system has a higher moisture content than typical MSW. The rotary dryer 20 reduces the moisture content of the material to around 15% by weight.

The material can also be screened using a vibrating sieve 21 after the material has passed through the rotary dryer 20 to remove remaining dense material should it be required.

The final product from the system is a solid recovered fuel (SRF). If necessary, or desired, the material output from the system can be burned to produce electrical power or hot air or hot water. It is possible to use the fuel as a supplementary fuel in a conventional fluidised bed boiler such as in power plants or in other industrial processing, for example for cement manufacture. An alternative example for the use of the end-product is as a feedstock for other energy from waste processes including: pyrolysis, gasification or production of bio-diesel.

The individual steps of the process will now be described with reference to a specific example.

### Disposal Area 10

The disposal area receives up to 250 t per day of MSW. On reception, typically this 250 t MSW consists of 138 t of solid material and 112 t of water contained within the solid material. This gives the MSW a moisture content of 45% by weight. The MSW will typically comprise paper and card, plastics, textiles, glass, metal, garden waste and kitchen waste.

### Conveyor Belt 12

The screening through the conveyor belt 12 is by hand picking and removes heavy plastics and iron, metal and glass. Approximately, 12% of the MSW is composed of these materials and therefore after this initial screening, 112 t of solid waste and 112 t of water remains, giving the waste a 50% moisture level by weight. Alternatively, MSW may be sorted by mechanical processes that are standard to the industry.

### The Static Aerated Bays 14

Three aerated static bays 14a, 14b, 14c are provided, which are constructed of concrete and each are of size 15 m×15 m×3 m which is 675 m³. The bays are provided with retractable roofs which are open to allow access during loading and are closed during operation. The roofs may be provided for health and environmental reasons for example to prevent access by birds and wild animals to the waste in the bays 14.

The bulk density of the waste material which is fed into each bay 14 is between 0.3 and 0.4 kg m⁻³ and each bay can therefore hold between around 200 t and 270 t of waste.

The waste is maintained in a bay 14 for 72 hours and therefore the incoming waste for each day is stored in a different storage bay.

Once the waste has been stored in the storage bay for around 6 hours it reaches a temperature of above 40° C. The temperature of the waste in each bay 14 is maintained at around 50-55° C. by injecting air into the waste from air channels in the base of the bays. Alternatively, as described above, the temperature control and biodrying strategy may adopt heating and cooling cycles with maximum and minimum control temperatures in the range of approximately 40° C. to 55° C., respectively.

### The Rotary Bio-Dryer 19

The RBD 19 comprises a circular cylindrical drum inclined at an angle of 7° to the horizontal and is 4 m in diameter and 25 m in length. Two RBDs 19 are provided and the output from a bay 14a, 14b or 14c is fed into one of the RBDs 19.

The drum is provided with lifters on its internal surface to aid in the agitation of the material within the drum. The lifters comprise of blades which project from the interior surface of the drum to a depth of up to around 36 cm. Preferably, five lifters are provided at the end of the drum where material is input into the drum (that is a lifter every 72° on the inner circumference of the drum). The number of lifters will decrease along the length of the drum.

The drum is provided with thermocouples along its length, spaced at approximately 5 m intervals. The drum is also provided with a sensor at the exit of the drum to measure the relative humidity of the air inside the drum. These sensors are provided to measure the temperature and the humidity of the waste and air within the drum to provide data to control the heating and cooling cycles.

The moisture content of the waste entering the RBD 19 is in the range of about 35 to 40% by weight and the density of the waste is around 0.45 kg m⁻³.

The waste is retained in the RBD for 48 hours and during this period the moisture content of the waste decreases from 35 to 40% to 15-25% by weight.

The RBD and its mode of operation are designed to maximise the conditions for aerobic biological heat generation and biodrying and to ensure that the shredded waste is thoroughly mixed during the residence time within the RBD. This is achieved through the use of heating and cooling cycles in combination with stationary and rotation cycles as described above.

The output from the RBD 19 comprises a homogeneous material of around 112 t solid waste and 30 t of moisture.

In an alternative embodiment, it is also possible to retain the waste in the RBD 19 for a further 24 hours, during which time the moisture content of the waste decreases from 15-25% to 10-15% by weight.

### The Rotary Dryer 20

As noted above this is an optional feature and is provided to ensure that the moisture content of the waste has been reduced to a suitable level by heating the material to around 90° C. It is particularly useful in wet environments when the MSW is of a high initial moisture content.

### Final Product

The final output of the system is a consistent solid recovered fuel product very suitable for use in industry, particularly the cement industry. It has a typical bulk density of between 120 to 170 kg m⁻³. The final product has a higher net calorific value than fuel produced from MSW using conventional methods. It has no odour and it can be safely stored for long periods. The net calorific value of the final product is around 3000-4200 kcal kg⁻¹, preferably 3400-3800 kcal kg⁻¹.

The properties of an example of the final product are illustrated in the table below and compared to petcoke.

| Parameter | Final Product | Petcoke |
|---|---|---|
| Carbon | 40-50% | 80-87% |
| Hydrogen | 4.0-4.5% | 4.0-4.5% |
| Nitrogen | 0.9-1.2% | 1.4% |
| Chlorine | <0.5% | 0.1% |
| Ash | 15-25% | 0.5-1.0% |
| Sulphur | 0.5-1.0% | 4.0-5.5% |
| Volatiles | 8.0-9.0% | 9.0-13% |
| Net calorific value | 3400 kcal/kg | 7500 kcal/kg |
| Moisture content by weight | 15-18% | 8.0-10% |

The example described above can process 250 t per day of MSW and approximately 80 to 90% of the MSW can be recycled. 250 t of MSW can produce 140 t of fuel, which contains about 30 t water and 80 t of moisture will be evaporated from the MSW during the treatment process. Approximately 25 t of the MSW is comprised of metals and glass which can be recycled in a conventional manner.

1. A method of treating municipal solid waste comprising the steps of:
shredding the waste to a first particle size;
storing the shredded waste in an aerated storage bay for a first period time;
shredding at least some of the waste to a second particle size; and
agitating the shredded waste in a rotating drum for a second period of time and then outputting the treated waste;
wherein biological decomposition under aerobic conditions takes place in the aerated storage bay and the rotating drum.

2. A method according to claim 1, wherein the first particle size is 100 mm or less.

3. A method according to claim 1 or 2, wherein the second particle size is 50 mm or less.

4. A method according to claim 1, wherein the first period of time is approximately 72 hours.

5. A method according to claim 1, further comprising the step of controlling airflow through the storage bay such that the temperature of the shredded waste is maintained at approximately 50-55° C.

6. A method according to claim 1, further comprising the step of applying a heating cycle and a cooling cycle to the waste during the first period of time;
wherein the maximum temperature of the heating cycle is approximately 55° C. and the minimum temperature of the cooling cycle is approximately 40° C.

7. A method according to claim 1, wherein the average moisture level in the shredded waste after the first period of time is reduced to around 35% to 40% by weight, by metabolically generated heat.

8. A method according to claim 1, wherein the second period of time is approximately 48 hours.

9. A method according to claim 1, further comprising the step of periodically applying a heating cycle and a cooling cycle to the waste during the second period of time.

10. A method according to claim 9, wherein the heating cycle comprises exposing the waste to a first airflow rate at a time when the rotating drum is stationary; and
the cooling cycle comprises exposing the waste to a second airflow rate, higher than the first airflow rate, at a time when the rotating drum is rotating.

11. A method according to claim 9 or claim 10, wherein the duration of each heating cycle and each cooling cycle is controlled such that the temperature of the waste in the rotating drum is maintained between around 40° C. and 55° C.

12. A method according to claim 11, further comprising the step of:
heating the second airflow to a temperature above the ambient temperature, before it enters the rotating drum;
wherein the second airflow is heated from heat generated from the biological decomposition in the storage bay.

13. A method according to claim 1, wherein the average moisture level in the shredded waste after the second period of time is reduced to around 15% to 25% by weight, by metabolically generated heat.

14. A method according to claim 1, further comprising the step of:
sorting, before the first shredding step, the municipal solid waste to remove non-combustible material from the waste.

15. A method according to claim 1, further comprising the step of:
feeding the treated waste from the rotating drum into a rotary dryer for a third period of time and heating the treated waste to a temperature of around 90° C. to reduce the average moisture level in the treated waste to around 15% by weight.

16. A system for treating municipal waste, the system comprising:
a first shredder arranged to shred the waste to a first particle size;
an aerated storage bay constructed to aerate the shredded waste;
a second shredder arranged to shred at least some of the stored waste to a second particle size;
a rotary drum arranged to agitate and aerate the waste; and
means for controlling the temperature and the moisture levels in the waste in the storage bay and the rotary drum such that biological decomposition under aerobic conditions takes place in the aerated storage bay and the rotary drum.

17. A system according to claim 16, further comprising a rotary dryer arranged to receive and reduce the moisture content of material output from the rotary drum.

18. A method of treating municipal solid waste comprising the steps of:
shredding at least some of the waste to a first particle size; and
agitating the shredded waste in a rotating drum for a period of time and then outputting the treated waste;
wherein biological decomposition under aerobic conditions takes place in the rotating drum.

19. The method according to claim 18, further comprising the step of controlling airflow through the rotating drum such that the temperature of the shredded waste is maintained at approximately 40-55° C.

20. The method according to any one of claim 18 or 19, further comprising the step of applying a heating cycle and a cooling cycle to the waste during the period of time;
wherein the maximum temperature of the heating cycle is approximately 55° C. and the minimum temperature of the cooling cycle is approximately 40° C.

21. The method according to claim 20, wherein the heating cycle comprises exposing the waste to a first airflow rate at a time when the rotating drum is stationary; and
the cooling cycle comprises exposing the waste to a second airflow rate, higher than the first airflow rate, at a time when the rotating drum is rotating.

22. The method according to claim 21, wherein the duration of each heating cycle and each cooling cycle is controlled such that the temperature of the waste in the rotating drum is maintained between around 40° C. and 55° C.

23. The method according to claim 22, further comprising the step of:
heating the second airflow to a temperature above the ambient temperature, before it enters the rotating drum.

24. A system for treating municipal waste, the system comprising:
a first shredder arranged to shred at least some of the waste to a first particle size;
a rotary drum arranged to agitate and aerate the waste; and
means for controlling the temperature and the moisture levels in the waste in the rotary drum such that biological decomposition under aerobic conditions takes place in the rotary drum.

25. A system according to claim 24, further comprising a rotary dryer arranged to receive and reduce the moisture content of material output from the rotary drum.
